(19) United States
(12) Patent Application Publication
(10) Pub. No.: US 2003/0028490 A1
(43) Pub. Date: Feb. 6, 2003

(54) System, apparatus, and method of contents distribution, and program and program recording medium directed to the same

(76) Inventors: Koji Miura, Matsubara (JP); Masaya Yamamoto, Hirakata (JP); Masahiro Oho, Neyagawa (JP)

Correspondence Address: WENDEROTH, LIND & PONACK, L.L.P., 2033 K STREET N. W., SUITE 800, WASHINGTON, DC, 20006-1021, US

(21) Appl. No.: 10/208,039

(22) Filed: Jul. 31, 2002

(30) Foreign Application Priority Data
Jul. 31, 2001 (JP) 2001-232117

(51) Int. Cl. G06F 17/60

(52) U.S. Cl. 705/59; 705/51

(57) ABSTRACT

There is provided a content distribution system which is capable of a distributing a content in accordance with a requested data format or the capabilities of a terminal used, and which can eliminate inequity associated with content distribution in different data formats, by altering a usage rule. During content purchase processing, in a content distribution apparatus 1, information concerning use of a content purchased by a user is registered in the user's right database 20 based on a user database 18 and a content right database 19. For each content, the content right database 19 previously stores one or more units of information concerning content usage including usage rules for different usage modes. During content use processing, based on the registered information, the content distribution apparatus 1 transmits to the user terminal 3 a license stipulating a usage rule corresponding to the usage mode of a requested content.

### BACKGROUND OF THE INVENTION

1. Field of the Invention

The present invention relates to a system, apparatus, and method of contents distribution, as well as a program and a program recording medium directed to the same. More particularly, the present invention relates to: a system for enabling user terminals coupled via a network to a content distribution apparatus to use contents (e.g., video or music), such that, at the time of using a content, the system provides usage rules in accordance with the data format of a requested content or the capabilities of a terminal used; a content distribution apparatus to be used in the system; a content distribution method performed in the system; as well as a content distribution program for executing the method and a medium having the program recorded thereon.

2. Description of the Background Art

As is well-known, there has been a trend for broadband adaptations in network (e.g., the Internet) connection environments, and services for distributing large-volume contents (e.g., video or music) to terminals such as personal computers (PCs) are becoming more and more prevalent.

As such services gain prevalence, users of a network are enabled to obtain various large-volume contents more easily and more rapidly. In a “paid” contents distribution service (which provides contents based on billing), it becomes very important, as such services gain prevalence, to manage contents in such a manner as to ensure that service-providing entities and copyright holders will not suffer from illegal copying and/or tampering of contents.

An example of a copyright management system which is intended to counteract such illegal copying and/or tampering of contents is disclosed in Japanese Patent Laid-Open Publication No. 7-131452.

In the management system disclosed in this publication, a transmitting end (e.g., a server) transmits an encrypted content, usage rules associated therewith, and a decrypting key to a receiving end (e.g., a terminal). Upon receiving them, the receiving end detects tampering and then verifies if the usage rules are met, and decodes and outputs the content only when all of the verifications are satisfied. As a result, illegal copying and/or tampering of contents are counteracted.

As used herein, the “usage rules” refer to the information used for restricting the usage of a content, and designates an allowable number of times of use or an allowable period of use, for example. A contents distribution service providing entity may designate an allowable period of use to embody a rental service, or alter the fee requirements for contents in accordance with the usage rules, thus realizing a variety of services. Due to these advantages, a contents distribution service often utilizes usage rules.

On the other hand, terminals which are capable of connecting to networks have also become diversified with the development in network infrastructure. For example, devices such as PCs, mobile phones, car navigation systems, and satellite broadcast reception systems may be utilized as terminals. Some future systems are envisioned in which home appliances are equipped with network connection functions so as to be able to receive distributed contents. As a result, home appliances such as a television set or a component stereo set, which conventionally function as special-purpose stand-alone devices, will be able to function as terminals.

Thus, as network adaptations within households become more advanced, users will become able to enjoy contents distribution services through the use of a number of terminals.

Now, devices which can thus function as terminals may vary in their content displaying (outputting) capabilities. For example, whereas a PC generally has a sufficient processing power and a large display screen, a mobile phone may be more limited than a PC with respect to processing power, display screen size and/or displayable colors. Most component stereo sets do not even have an image displaying function.

Therefore, some contents distribution service distribute contents in data formats which are adapted to the capabilities of each terminal used. For example, in the case of distributing a movie content, a content may be distributed as it is (e.g., in the MPEG2 data format) to a user whose terminal is a PC, or distributed in a format (e.g., in the MPEG4 data format) obtained by reducing the image size or thinning out the frames to a user whose terminal is a mobile phone. Even if the terminal used is a PC, it may still be desirable to change the data format of the content to be distributed.

In such a contents distribution service, it is usually the case that the same fee is billed for the same content even if distributed in different data formats. However, from the user's point of view, it is inequitable that a regular fee should be charged in the case where the distributed content is inferior in quantity or quality due to a special data format being used, despite the fact that the content is meant to be directed to the same substance.

In order to resolve this inequity problem, it might be possible to apply different billings depending on the data format of a requested content or on the capabilities of each terminal. For example, the billing may be set at ¥1,000 for use on a PC and ¥500 for use on a mobile phone. However, these billing amounts are fixed; moreover, at the time of purchasing the content, a user who possesses a plurality of terminals is not likely to be sure as to which terminal he/she wants to have contents distributed to. Thus, it may be difficult for the user to determine which distribution mode (and hence billing amount) the distribution contract should be made with respect to.

Accordingly, a technique of dynamically changing a fee which is billed for a content depending on the data format in which the content is actually distributed is disclosed in Japanese Patent Laid-Open Publication No. 2000-270309. In accordance with the technique described in this publication, a user makes a contract based on a fee required for a predetermined default data format at the time of purchasing a content. Thereafter, a distribution service provider refunds a predetermined difference to the user if the user happens to have the content distributed in a data format which is inferior in quantity or quality to the default data format, and collects a predetermined additional fee from the user if the actual data format used is superior in quantity or quality to the default data format.

However, this conventional solution has a problem in that, since the refund or additional collection of fees may occur frequently, complicated billing transactions may be required on the part of the distribution service provider, and the user may have difficulties in keeping track of the amounts of money actually paid.

### SUMMARY OF THE INVENTION

Therefore, an object of the present invention is to provide a system, apparatus, and method of contents distribution which is capable of distributing a content depending on the required data format or the capabilities of each terminal used, and resolving inequity problems associated with contents distribution in different data formats by altering usage rules rather than altering billing fees, as well as to provide a program and a program recording medium directed to the same.

The present invention has the following features to attain the object above.

A first aspect of the present invention is directed to a content distribution system in which a content distribution apparatus distributes a content to at least one user terminal, wherein, in response to a request for use of a content transmitted from the at least one user terminal, and based on information concerning content usage including usage rules which are prescribed respectively corresponding to a plurality of usage modes, the content distribution apparatus dynamically generates a license stipulating a usage rule corresponding to a usage mode of the requested content, and transmits the generated license to the user terminal, and the user terminal controls use of the content in accordance with the received license.

Thus, according to the first aspect, in accordance with the usage mode of a requested content, the content distribution apparatus (corresponding to a content provider) can provide a user with a dynamically-changed usage rule for the content. Therefore, even though the same fee is billed with respect to the content, the inequity associated with distributing a content in different usage modes can be eliminated.

Preferably, each usage mode is defined as a data format of a content, and the content distribution apparatus generates the license so as to stipulate a usage rule corresponding to a data format of the content designated in the request for use. Alternatively, each usage mode is defined as capabilities of the at least one user terminal, and the content distribution apparatus generates the license so as to stipulate a usage rule corresponding to the capabilities of the user terminal from which the request for use is transmitted.

Thus, the user is provided with a usage rule for a content which is in accordance with the data format of the requested content or the capabilities of the terminal used.

Typically, the content distribution apparatus comprises: a user database operable to store user-related information; a content right database operable to store, for each content, information concerning content usage including usage rules which are prescribed respectively corresponding to a plurality of usage modes; a user's right database operable to store a right granted to a user; a content database operable to store contents; a user right registration section operable to register a right granted to a user having purchased a content in the user's right database based on the user-related information and the information concerning content usage; a user right generation section operable to generate, in response to a request for use of a content transmitted from the at least one user terminal, a license including a usage rule corresponding to the usage mode of the requested content; a content management section in charge of management/control of contents; and a communication section operable to transmit and receive the license, the content, and the request for use to/from the user terminal, and wherein the user terminal comprises: a communication section operable to transmit and receive the request for use, the license, and the content to/from the content distribution apparatus; a license database operable to store the received license; a content storage section operable to store the received content; and a management section in charge of use and management of the received content according to the license stored in the license database.

In accordance with this structure, at the time of content purchasing, a right granted to a user can be registered in the user's right database based on a user database and a content right database previously storing usage rules corresponding to a plurality of usage modes. Thus, when a request for use of a content is transmitted from the user terminal, a usage rule corresponding to the requested content can be provided for the user by referring to the registered entries in the user's right database.

A second aspect of the present invention is directed to a content distribution method for allowing a content distribution apparatus to distribute a content to at least one user terminal, wherein, at a time of content purchasing, the user terminal notifies to the content distribution apparatus that a content is purchased in a usage mode; the content distribution apparatus registers user-related information concerning a user having purchased a content, and registers a right granted to the user having purchased the content based on information concerning content usage including usage rules which are prescribed respectively corresponding to a plurality of usage modes and based on the user-related information, and wherein, at a time of content using, the user terminal transmits to the content distribution apparatus a request for use of a content including information concerning a usage mode of the content; in accordance with the request for use transmitted from the user terminal, the content distribution apparatus dynamically generates a license stipulating a usage rule corresponding to the usage mode of the requested content, and transmits the generated license to the user terminal; and the user terminal uses and manages the requested content in accordance with the license transmitted from the content distribution apparatus.

Thus, according to the second aspect, in the content distribution apparatus (corresponding to a content provider), at the time of content purchasing, a right granted to a user is registered on the basis of usage rules which are previously stored corresponding to a plurality of usage modes. Accordingly, by referring to the register right, a content can be provided for the user, the usage rule thereof being dynamically changed depending on the usage mode of the requested content. As a result, even though the same fee is billed with respect to the content, the inequity associated with distributing a content in different usage modes can be eliminated.

Preferably, at the time of content purchasing, the user terminal transmits a request to purchase a content to the content distribution apparatus, and wherein the content distribution apparatus transmits the information concerning content usage to the user terminal.

Thus, at the user terminal (corresponding to a content user), it is possible to determine in which usage mode to purchase a content while being able to confirm the usage rules which are prescribed for each content.

Preferably, each usage mode is defined as a data format of a content, and the content distribution apparatus generates the license so as to stipulate a usage rule corresponding to a data format of the content designated in the request for use. Alternatively, each usage mode is defined as capabilities of the at least one user terminal, and the content distribution apparatus generates the license so as to stipulate a usage rule corresponding to the capabilities of the user terminal from which the request for use is transmitted.

Thus, the user is provided with a usage rule for a content which is in accordance with the data format of the requested content or the capabilities of the terminal used.

Preferably, before receiving the request for use, the content distribution apparatus transmits to the user terminal at least one content corresponding to a data format to be subsequently requested or the capabilities of the user terminal.

Preferably, after responding to the request for use, the content distribution apparatus transmits to the user terminal the content corresponding to the requested data format or the capabilities of the user terminal.

A third aspect of the present invention is directed to a content distribution program executed by a content distribution apparatus for distributing a content to at least one user terminal, comprising: a step of registering user-related information concerning a user having purchased a content; a step of registering a right granted to the user having purchased the content based on information concerning content usage including usage rules which are prescribed respectively corresponding to a plurality of usage modes and based on the user-related information; a step of dynamically generating a license stipulating a usage rule corresponding to the usage mode of the requested content, in accordance with the request for use transmitted from the user terminal at a time of content using; and a step of transmitting the generated license to the user terminal.

Preferably, the step of dynamically generating the license comprises generating the license so as to stipulate a usage rule corresponding to a data format of the content designated in the request for use.

Preferably, the step of dynamically generating the license comprises generating the license so as to stipulate a usage rule corresponding to the capabilities of the user terminal from which the request for use is transmitted.

A fourth aspect of the present invention is directed to a content distribution program to be executed by at least one user terminal receiving a content distributed from a content distribution apparatus, comprising: a step of, at a time of content purchasing, notifying to the content distribution apparatus that a content is purchased in a usage mode; a step of, at a time of content using, transmitting to the content distribution apparatus a request for use of a content including information concerning a usage mode of the content; and a step of using and managing the requested content in accordance with the license transmitted from the content distribution apparatus.

A fifth aspect of the present invention is directed to a content distribution apparatus for distributing a content to at least one user terminal, comprising: a user database operable to store user-related information; a content right database operable to store, for each content, information concerning content usage including usage rules which are prescribed respectively corresponding to a plurality of usage modes; a user's right database operable to store a right granted to a user; a content database operable to store contents; a user right registration section operable to register a right granted to a user having purchased a content in the user's right database based on the user-related information and the information concerning content usage; a user right generation section operable to generate, in response to a request for use of a content transmitted from the at least one user terminal, a license including a usage rule corresponding to the usage mode of the requested content; a content management section in charge of management/control of contents; and a communication section operable to transmit and receive the license, the content, and the request for use to/from the user terminal.

Preferably, each usage mode is defined as a data format of a content, and the user right generation section generates the license so as to stipulate a usage rule corresponding to a data format of the content designated in the request for use. Alternatively, each usage mode is defined as capabilities of the at least one user terminal, and the user right generation section generates the license so as to stipulate a usage rule corresponding to the capabilities of the user terminal from which the request for use is transmitted.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram illustrating the structure of a content distribution system according to an embodiment of the present invention;

FIG. 2 is a flowchart illustrating content purchase processing performed by a content distribution system according to an embodiment of the present invention;

FIG. 3 is a conceptual illustration of an example of information concerning content usage stored in a content right database 19;

FIG. 4 is a conceptual illustration of an example of user information stored in a user database 18;

FIG. 5 is a conceptual illustration of an example of information concerning rights granted to users stored in a user's right database 20;

FIG. 6 is a conceptual illustration of an example of content information stored in a content database 21;

FIG. 7 is a flowchart illustrating content use processing performed by a content distribution system according to an embodiment of the present invention; and

FIG. 8 is a conceptual illustration of another example of user information stored in the user database 18.

### DESCRIPTION OF THE PREFERRED EMBODIMENTS

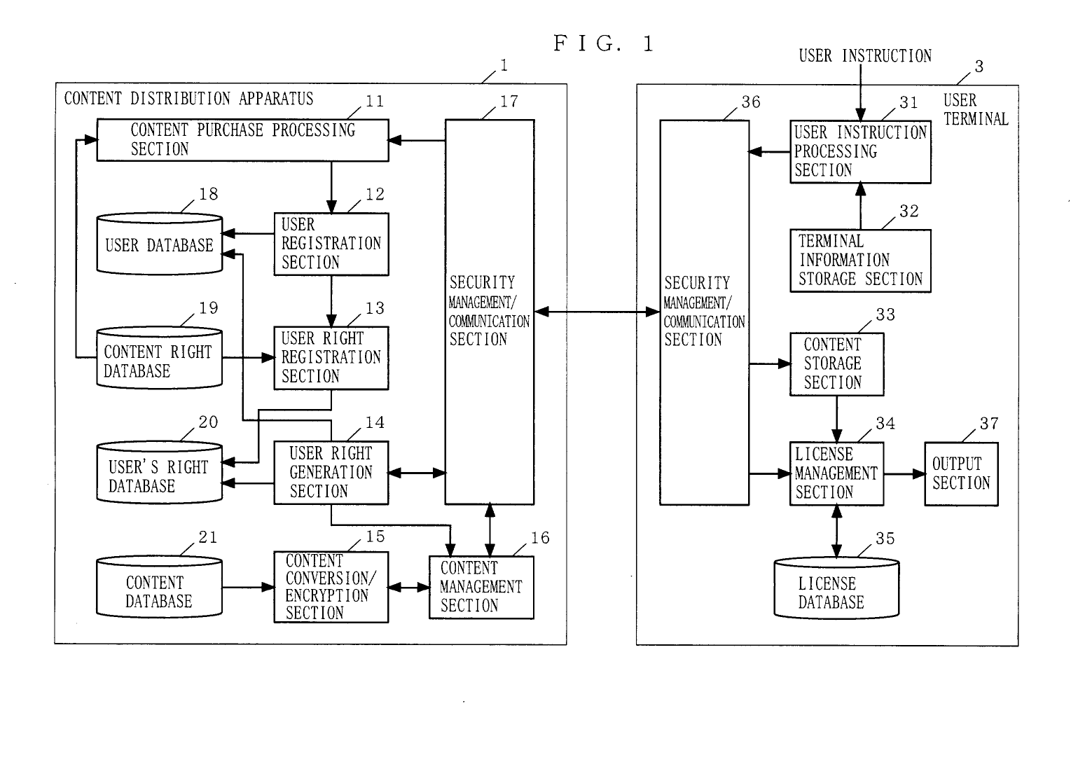

FIG. 1 is a block diagram illustrating the structure of a content distribution system according to an embodiment of the present invention. As shown in FIG. 1, the content distribution system according to the present embodiment of the invention comprises a content distribution apparatus 1 (corresponding to a service provider) and a user terminal 3 (corresponding to a user), which are interconnected via a transmission path, e.g., a network.

The content distribution apparatus 1 comprises a content purchase processing section 11, a user registration section 12, a user right registration section 13, a user right generation section 14, a content conversion/encryption section 15, a content management section 16, a security management/communication section 17, a user database 18, a content right database 19, a user's right database 20, and a content database 21. The user terminal 3 comprises a user instruction processing section 31, a terminal information storage section 32, a content storage section 33, a license management section 34, a license database 35, a security management/communication section 36, and an output section 37.

First, the content distribution apparatus 1 and the user terminal 3 composing the content distribution system will be briefly described.

The respective elements in the content distribution apparatus 1 perform the following processes. When performing content purchasing processing, the content purchase processing section 11 transmits information concerning the substance, a usage rule, a fee, and the like of each content, which are stored in the content right database 19, to the user terminal 3 for preview by a user. When a user wishes to purchase a content, the content purchase processing section 11 obtains user information (e.g., a user ID, a terminal ID, a user name, and a telephone number) from the user terminal 3, and performs necessary billing transactions. In the content right database 19, one or more units of information concerning content usage are stored corresponding to each content (e.g., a movie such as a cinema or TV broadcast program, a still image of a book or printed matter, audio such as radio broadcasting or narration, music, and/or a game).

The user registration section 12 registers the user information obtained by the content purchase processing section 11 in the user database 18. The user database 18 has a cumulative record of information concerning users who have purchased contents.

The user right registration section 13 registers information concerning a content purchased by a user, which is supplied from the content purchase processing section 11 via the user registration section 12, as a right granted to the user in the user's right database 20. The user's right database 20 stores licenses associated with contents purchased by users.

In response to a request for use of a content received from the user terminal 3, the user right generation section 14 generates a license (a usage rule, a decrypting key to the content, etc.) to be transmitted to the user terminal 3. The content database 21 stores various contents.

In accordance with an instruction from the content management section 16, the content conversion/encryption section 15 optionally performs necessary processing to convert a content stored in the content database 21 into a data format which corresponds to the request for use or is suitable for the user terminal 3, and performs a predetermined encryption for the content.

The content management section 16 is in charge of management of the general content processing, such as transmission of contents to the user terminal 3.

The security management/communication section 17 authenticates the user terminal 3, and realizes a secure communication between the content distribution apparatus 1 and the user terminal 3. The well-known SSL protocol or the like may be used for this secure communication.

The respective elements in the user terminal 3 perform the following processes. The user instruction processing section 31 processes an instruction inputted by the user (e.g., a request to purchase a content or a request for use of a content).

The terminal information storage section 32 stores the aforementioned user information.

The content storage section 33 stores an encrypted content which has been obtained through a purchase.

In response to a request for use of a content, the license management section 34 receives the license which is transmitted from the content distribution apparatus 1, and subjects the relevant content to processing (e.g., decrypting and reproduction based on the usage rule) in accordance with what is defined under the license. The license is kept under management and stored in the license database 35.

The output section 37, which may be a display device, etc., outputs a content as processed by the license management section 34.

The security management/communication section 36 authenticates the content distribution apparatus 1, and realizes a secure communication between the content distribution apparatus 1 and the user terminal 3. This secure communication may also be based on the SSL protocol or the like.

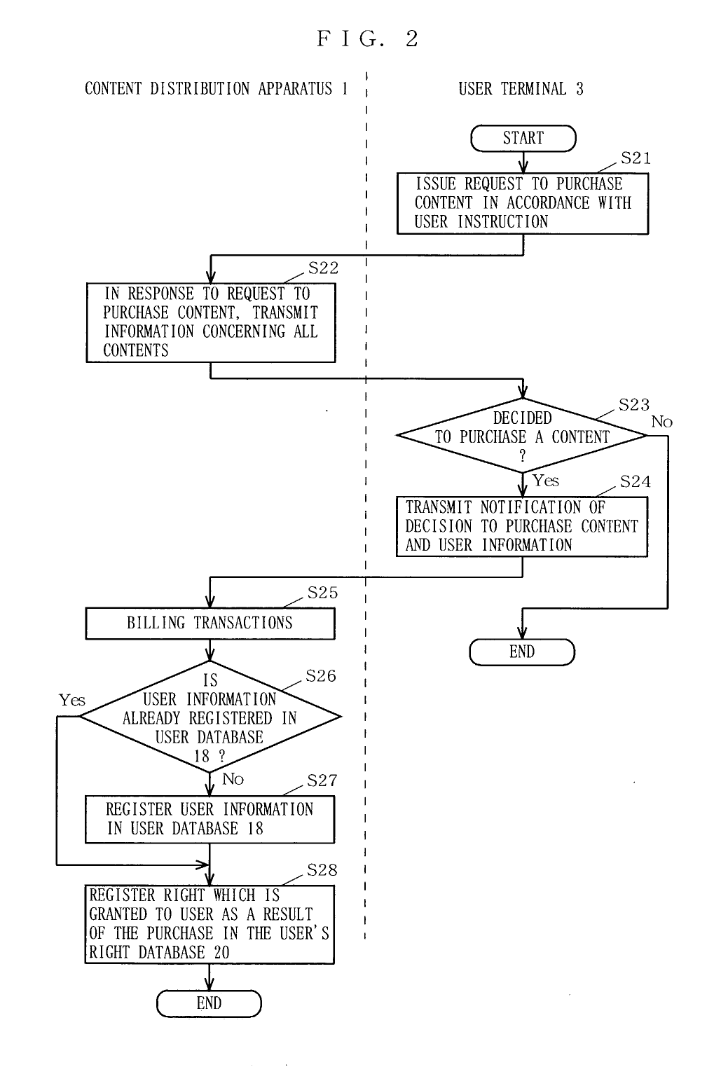

Next, a content distribution method performed in the content distribution system according to the present embodiment of the invention will specifically be described with reference to FIGS. 2 to 8.

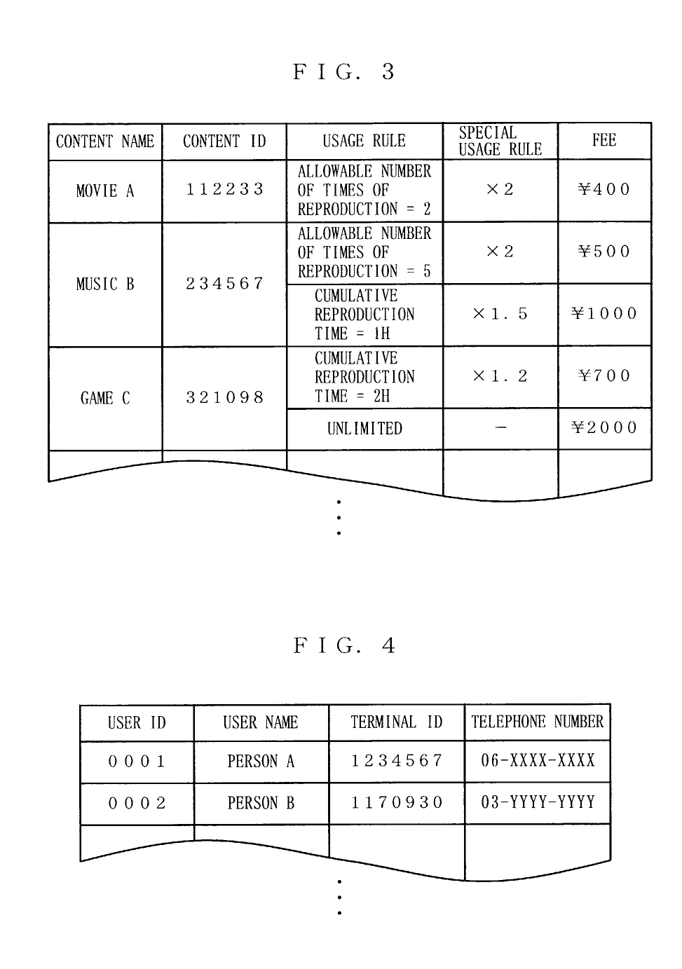

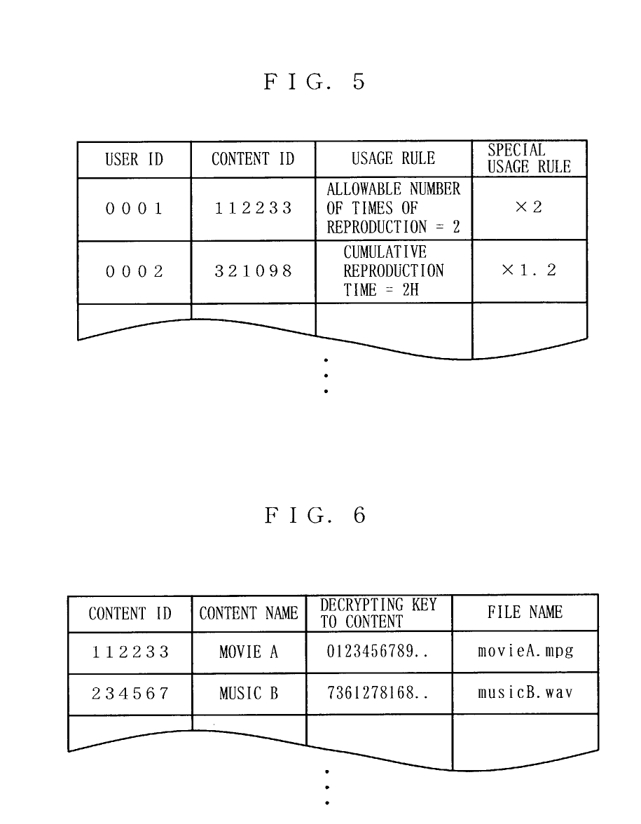

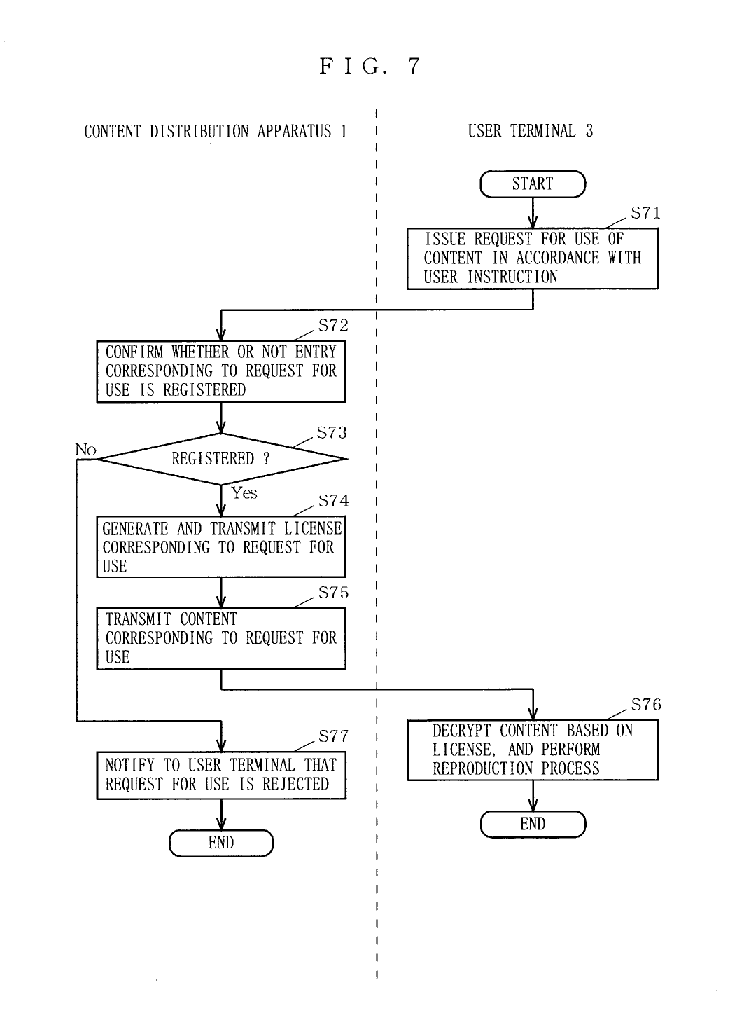

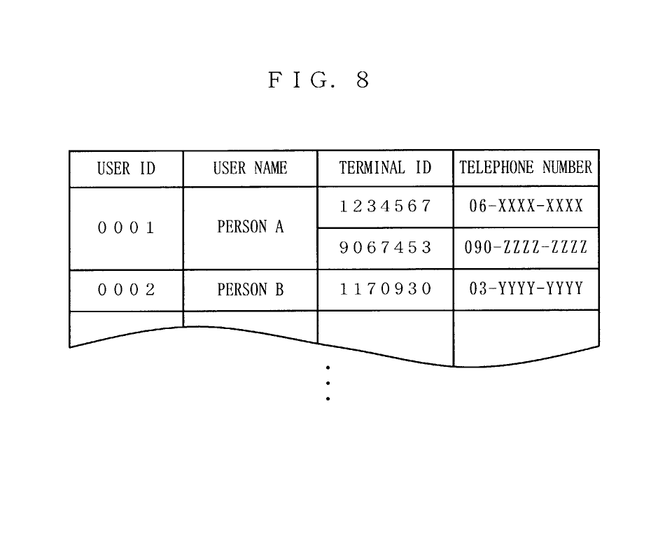

FIG. 2 is a flowchart illustrating content purchase processing performed by the content distribution system according to the present embodiment of the invention. FIG. 3 is a conceptual illustration of an example of information concerning content usage stored in the content right database 19. FIGS. 4 and 8 are conceptual illustrations of examples of user information stored in the user database 18. FIG. 5 is a conceptual illustration of an example of information concerning rights granted to users stored in the user's right database 20. FIG. 6 is a conceptual illustration of an example of content information stored in the content database 21. FIG. 7 is a flowchart illustrating processing related to use of a content performed by the content distribution system according to the present embodiment of the invention.

(1) Content Purchase Processing

With reference to FIG. 2, an exemplary processing which is performed by the content distribution system when a user purchases a content provided from the content distribution apparatus 1 will be described.

At the user terminal 3, a user issues an instruction concerning a purchase of a content to the user instruction processing section 31. Via the security management/communication section 36, the user instruction processing section 31 issues a request to purchase a content, which is in accordance with the instruction from the user, to the content distribution apparatus 1 (step S21).

In the content distribution apparatus 1, the request to purchase a content issued from the user terminal 3 is received by the content purchase processing section 11 via the security management/communication section 17. Upon receiving the request to purchase a content, the content purchase processing section 11 obtains information concerning all of the contents stored in the content right database 19, and transmits it to the user terminal 3 via the security management/communication section 17 (step S22).

For example, information as shown in FIG. 3 may be stored in the content right database 19. Referring to FIG. 3, a “content name” denotes the name of each content, and a “content ID” denotes a number which is uniquely assigned to identify each content. A “usage rule” denotes a specific rule for allowing a user to use each content in a predetermined data format which is regularly used (hereinafter referred to as a “regular data format”). A “special usage rule” denotes how the usage rule is changed when the content is used in a data format different from the regular data format (hereinafter referred to as a “special data format”). The example of FIG. 3 illustrates a case where the regular data format is superior in quality or quantity to the special data format, e.g., the regular data format being MPEG2 and the special data format being MPEG4. A “fee” denotes a price (billing amount) necessary for enjoying a content according to the usage rule or the special usage rule. One or more usage rules, one or more special usage rules, and/or one or more fees may be prescribed for each content. In this example, a usage rule for a content named “movie A” is set in terms of an allowable number of times of reproduction, indicating that for a fixed fee of ¥400, a user is allowed to watch movie A twice in the MPEG2 data format, or four times (=twice×2) in the MPEG4 data format.

Although the example of FIG. 3 illustrates the case where the regular data format is superior in quality or quantity to the special data format, the regular data format may alternatively be inferior in quality or quantity to the special data format, with the usage rule and the special usage rule being appropriately set. In the case where a plurality of special data formats are available, respectively different special usage rules may be prescribed therefor. In the alternative or in addition to the aforementioned allowable number of times of use or allowable total time of use, various other conditions may be stipulated as the usage rule, e.g., an allowable period of use, or enablement/disablement of copying to a recording medium copy or printing on paper.

Referring back to FIG. 2, in the user terminal 3, as the user decides to purchase one of the contents based upon information concerning content usage (FIG. 3) transmitted from the content purchase processing section 11 (following the “Yes” path from step S23), the user instruction processing section 31 transmits the user information stored in the terminal information storage section 32, together with a notification of decision to purchase a content (including information concerning the purchased content and the selected usage rule), to the content distribution apparatus 1 via the security management/communication section 36 (step S24).

In the content distribution apparatus 1, the notification of decision to purchase a content and the user information which are transmitted from the user terminal 3 are received by the content purchase processing section 11, via the security management/communication section 17. Then, the content purchase processing section 11 performs necessary billing transactions, and transfers the information concerning the purchased content and the user information to the user registration section 12 (step S25). The billing transactions, which do not form an essential part of the present invention, are omitted from descriptions herein.

The user registration section 12 transmits the information concerning the purchased content and the user information outputted from the content purchase processing section 11 to the user right registration section 13, and registers the user information in the user database 18 (step S27). If the same substance as the user information which is outputted from the content purchase processing section 11 is already registered in the user database 18, this user registration is not performed (following the “Yes” path from step S26).

For example, information as shown in FIG. 4 may be stored in the user database 18. Referring to FIG. 4, a “user ID” denotes a number which is uniquely assigned to identify each user. A “user name” denotes the name of each user. A “terminal ID” denotes a number which is uniquely assigned to identify each terminal; this field may be utilized in the case where a plurality of terminals are possessed by one user, for example. A “telephone number” is utilized in order to identify each user. In the example of FIG. 4, a statement that “a user named ‘person A’ and having an ID number ‘0001’ uses a terminal having an ID number ‘1234567’” is registered as user information.

Based on the information concerning the purchased content and the user information outputted from the user registration section 12 , the user right registration section 13 registers a right granted to a user concerning use of a content, which will be granted as a result of a purchase, in the user's right database 20 (step S28).

For example, information as shown in FIG. 5 may be stored in the user's right database 20. Referring to FIG. 5, a “user ID” denotes information which is registered in the user database 18. A “content ID”, a “usage rule”, and a “special usage rule” respectively denote information which is registered in the content right database 19.

Through the above processing, a purchase of a content and a registration of a right granted to a user associated with the purchase are completed.

(2) Content Use Processing

With reference to FIG. 7, an exemplary processing which is performed by the content distribution system when a user uses a purchased content after the right granted to the user has been registered in the user's right database 20 through the above-described processing will be described.

At the user terminal 3, a user issues an instruction concerning use of a content to the user instruction processing section 31. At this time, the user instructs how the user is going to use the content and in what data format the user wants the content. As an example of the former, the user may instruct how many times (assuming that the usage rule stipulates an allowable number of times), or how many minutes (assuming that the usage rule stipulates an allowable period of time) the user wishes to use the purchased content. As an example of the latter, the user may instruct whether the desired data format is MPEG2 or MPEG4, for example. In accordance with this user instruction, the user instruction processing section 31 issues a request for use of a content to the content distribution apparatus 1 via the security management/communication section 36 (step S71). The request for use does not need to be generated in accordance with a user instruction, but may automatically be generated within the user terminal 3. For example, in the case where the terminal only supports a limited usage rule and data format for the content, the request for use can be generated within the user terminal 3 without requiring a user instruction. A specific example would be where the user terminal 3 can obtain and process one usage rule at a time due to limited memory capacity, or can only reproduce MPEG4. In such cases, a request for use which is in accordance with the specific terminal may be automatically generated in the user instruction processing section 31 and issued to the content distribution apparatus 1. The request for use includes the substance of the aforementioned instruction, a user ID, a terminal ID, and a content ID.

In the content distribution apparatus 1, a request for use of a content issued from the user terminal 3 is received by the user right generation section 14 via the security management/communication section 17. Upon receiving the request for use, the user right generation section 14 confirms by referring to the user database 18 and the user's right database 20 as to whether any entry corresponding to the request is registered or not (step S72). Specifically, the user right generation section 14 confirms whether the user ID and terminal ID contained in the request for use are registered in the user database 18 or not. If they are determined to have been registered, then it is confirmed whether or not a content ID and a usage rule according to the user's instruction, contained in the request for use, is registered in the user's right database 20 under that user ID.

If it is determined at step S72 that an entry corresponding to the request for use is registered (following the “Yes” path from step S73), the user right generation section 14 generates a license corresponding to the request for use, and transmits them to the user terminal 3 via the security management/communication section 17 (step S74). The user right generation section 14 notifies the content ID and the data format contained in the request for use to the content management section 16. The content management section 16 retrieves a content corresponding to the content ID from the content database 21, subjects it to conversion to a requested data format and encryption in the content conversion/encryption section 15 as necessary, and transmits it to the user terminal 3 via the security management/communication section 17 (step S75).

On the other hand, if it is determined at step S72 that no entry corresponding to the request for use is registered (following the “No” path from step S73), the user right generation section 14 notifies that the request for use is rejected to the user terminal 3 via the security management/communication section 17 (step S77).

The generation of a license at step S74 is performed as follows. It is assumed that a user of the user ID “0001” has previously purchased a content in accordance with the registration in the user's right database 20 shown in FIG. 5.

It is further assumed that the user has transmitted a request for a single-time use of a content of the content ID “112233” in the MPEG2 data format. In this case, since the usage rule registered in the user's right database 20 is relevant to the regular data format of MPEG2, the user right generation section 14 generates a license so as to include information concerning an allowable number of times of reproduction=1 as requested and a decrypting key to the content. At the same time of generating the license, the user right generation section 14 reduces the allowable number of times registered in the usage rule in the user's right database 20 by one, thereby updating the registered entry (i.e., “2”→“1” in the example shown in FIG. 5).

In contrast, if the same user has transmitted a request for a single-time use of the content of the content ID “112233” in the MPEG4 data format, since the usage rule is relevant to the regular data format of MPEG2, the user right generation section 14 generates a license so as to include usage information concerning an allowable number of times of reproduction=2, i.e., the requested number of times being doubled (pursuant to the special usage rule), and a decrypting key to the content. At the same time of generating the license, the user right generation section 14 reduces the allowable number of times registered in the usage rule in the user's right database 20 by one in the same manner as described above, thereby updating the registered entry.

If the usage rules which have been granted through purchases of contents are depleted as a result of updating the entries registered in the user's right database 20 each time issuing a license to the user terminal 3, the entry of right granted to the user registered in the user's right database 20 may be deleted or retained. If the entry is retained, the processing required when the same user again purchases the same content, or when the user returns the obtained license unused, will be facilitated.

The transmission of a content at step S75 is performed as follows. It is assumed that, as shown in FIG. 6, the content database 21 previously stores the content of the content ID “112233” only in the MPEG2 data format.

It is further assumed that the user has transmitted a request for a single-time use of a content of the content ID “112233” in the MPEG2 data format. In this case, the content in the MPEG2 data format is retrieved from the content database 21 into the content conversion/encryption section 15. The retrieved content is subjected to predetermined encryption by the content conversion/encryption section 15, and thereafter transmitted from the content management section 16 to the user terminal 3.

In contrast, if the same user has transmitted a request for a single-time use of the content of the content ID “112233” in the MPEG4 data format, the content in the MPEG2 data format is similarly retrieved from the content database 21 to the content conversion/encryption section 15. The retrieved content is converted by the content conversion/encryption section 15 to the MPEG4 data format, subjected to predetermined encryption, and thereafter transmitted from the content management section 16 to the user terminal 3.

The content previously stored in the content database 21 may alternatively be in the MPEG4 data format.

In another alternative case where contents in both the MPEG2 and MPEG4 data formats are previously stored in the content database 21, the content in the requested data format may simply be retrieved and transmitted to the user terminal 3, without the need to perform a data format conversion in the content conversion/encryption section 15. In that case, the contents stored in the content database 21 may previously have been encrypted. In the case where encrypted contents are stored, the content conversion/encryption section 15 does not perform an encryption process. Therefore, the content conversion/encryption section 15 may be omitted in this case.

Referring back to FIG. 7, in the user terminal 3, the encrypted content which is transmitted from the content distribution apparatus 1 is stored in the content storage section 33, and the license is inputted to the license management section 34. The license management section 34 decrypts the content by using the decrypting key included in the obtained license, and carries out a reproduction process and the like for decrypted content according to the usage rule, by means of the output section 37 (step S76). The obtained license is stored in the license database 35, so as to be utilized for the management of an allowable number of times of reproduction and/or total time for the content.

Through the above processing, a content in a required data format can be distributed, and the usage rule for the content can be dynamically changed in accordance with the data format before being provided to the user.

(3) Application Directed to Users Possessing a Plurality of Terminals

The above-described content purchase processing and content use processing are directed to the case where one user uses one user terminal 3 to request contents distribution. In contrast, the following processing is directed to the case where one user possessing a plurality of user terminals 3 requests contents distribution.

It is assumed that a user who possesses as user terminals 3 a PC which is capable of using a content in a regular data format and a mobile phone which is capable of using a content in a special data format is desiring contents distribution through both of these terminals.

In this case, the following processes are performed in content purchase processing. When making decision to purchase a content, a user transmits the user information stored in the respective terminal information storage sections 32 of the PC and the mobile phone to the content distribution apparatus 1 via the security management/communication section 36.

In the content distribution apparatus 1, the user registration section 12 receives the information concerning the purchased content and the user information transmitted from the user terminal 3, via the security management/communication section 17 and the content purchase processing section 11. The user registration section 12 registers user information as shown in FIG. 8 in the user database 18. FIG. 8 illustrates an example where terminal IDs respectively corresponding to a number of user terminals 3 possessed are assigned to one user (person A).

If the number of user terminals 3 possessed by a user changes, e.g., a plurality of terminals become possessed not at the time of content purchasing but at a later time, the registration in the user database 18 can be updated when the change occurs. Particularly in the case where a new user terminal 3 is additionally registered, in order to prevent illegal use by a third party, it may be ensured that only a request for additional registration transmitted from the already-register user terminal 3 is accepted, or that the already-registered user terminal 3 is accessed for confirmation or verification with respect to any request for additional registration transmit from the new user terminal 3.

The following processes are performed in the content use processing. When a request for use of a content (e.g., a content ID=112233, a use of content=one time) is issued from the PC user terminal 3, the content distribution apparatus 1 confirms whether an entry corresponding to this request for use is registered or not, in the manner described above. If the entry is determined to have been registered, the user right generation section 14 generates a license. At this point, the user right generation section 14 determines that the request for use has been issued from a PC (as known from its terminal ID), and notifies to the content management section 16 that a content in the MPEG2 data format is to be transmitted, and generates a license including information stipulating an allowable number of times of reproduction=1 and a decrypting key to the content.

On the other hand, if a request for use of a content (e.g., a content ID=112233, a use of content=one time) is issued from the mobile-phone user terminal 3, the content distribution apparatus 1 confirms whether an entry corresponding to this request for use is registered or not, in the manner described above. If the entry is determined to have been registered, the user right generation section 14 generates a license. At this point, the user right generation section 14 determines that the request for use has been issued from a mobile phone (as known from its terminal ID), and notifies to the content management section 16 that a content in the MPEG4 data format is to be transmitted, and generates a license including information stipulating an allowable number of times of reproduction=2(=1×2) and a decrypting key to the content.

Thus, in the case where a user possessing a plurality of user terminals 3 desires to use a content by means of two or more user terminals 3, user information is registered in the user database 18 with respect to each user terminal 3 in the content distribution apparatus 1. When a request for use of a content is received, the content distribution apparatus 1 transmits a content and a license, such that the data format of the content and the license are in accordance with the user terminal 3 from which the request has been issued. Accordingly, by prescribing a data format for each user terminal 3, a user can enjoy the desired content always in the appropriately-selected data format, without having to designate a data format at the time of requesting use of the content.

The above embodiment illustrates an example where information such as the data format of a content requested by the user terminal 3 and the processing capabilities of the user terminal 3 is determined based on a terminal ID contained in the request for use of a content, Alternatively, in the aforementioned case where the user terminal 3 is capable of automatically generating and issuing to the content distribution apparatus 1 a request for use containing a data format and a usage rule, the above information can be determined based on the data format and usage rule contained in the request for use. In this case, the content distribution apparatus 1 no longer needs to have data formats corresponding to user terminals 3 registered in a database.

As described above, in the content distribution system and method according to one embodiment of the present invention, usage rules for contents distribution in different data formats are prescribed for each content. As a result, a content can be distributed to the user in a manner according to the requested data format or the capabilities of the terminal used, with the usage rule for the content being dynamically changed depending on the data format thereof. Thus, even though the same fee is billed with respect to the content, the inequity associated with distributing a content in different data formats can be eliminated.

The above embodiment illustrates an example where a content transmission from the content distribution apparatus 1 to the user terminal 3, i.e., storage of a content in the content storage section 33, occurs at the time when a response for a request for use of a content is made. However, the content transmission may occur with any other timing. For example, the storage of each content may occur when the processing of a notification of decision to purchase a content, which is received from the user terminal 3 by the content distribution apparatus 1, is completed. However, in the case where the storage of each content occurs with this timing and where a plurality of data formats are available for use at the user terminal 3, each content needs to be redundantly stored in different data formats, or each content may be stored in one data format only and complemented by a data format conversion function provided at the user terminal 3.

The above embodiment illustrates a case where a content is encrypted for transmission. However, in the case where encryption is unnecessary, the license generated by the user right generation section 14 do not need to include a content decrypting key, and there is no need to perform encryption for contents in the content conversion/encryption section 15.

Although the above embodiment illustrates an example where the content purchase processing section 11 is incorporated in the content distribution apparatus 1, the content purchase processing section 11 may be provided separately from the content purchasing apparatus. The above embodiment illustrates an example where the contents distribution processing function (the content database 21, the content conversion/encryption section 15, and the content management section 16), and the user's right processing function (i.e., any other sections and databases) are realized within a single content distribution apparatus 1. However, the portion realizing the contents distribution processing function may be provided separately from the portion realizing the user's right processing function. In that case, the contents distribution processing which is met with a high processing load can be executed separately from the user's right processing, so that the load associated with the user's right processing can be reduced.

Furthermore, the above embodiment illustrates an example where the security management/communication sections 17 and 36 are provided so that the communications between the content distribution apparatus 1 and the user terminal 3 are all realized in the form of secure communications. However, it is not particularly necessary to conduct a secure communication with respect to a request to purchase a content given in content purchase processing which is not of a confidential nature, or with respect to encryption contents which are already ensured to be confidential.

As described above, the system, apparatus, and method of content distribution according to the present invention, as well as the program and program recording medium therefor, are such that a content is distributed in accordance with a requested data format or the capabilities of the terminal to be used, and the usage rule for the content is dynamically changed depending on the data format thereof. As a result, when a user terminal which is connected to a content distribution apparatus via a network uses a content such as video or music, etc., the inequity felt by each user in connection with the data format of the distributed content or the billing content can be eliminated.

While the invention has been described in detail, the foregoing description is in all aspects illustrative and not restrictive. It is understood that numerous other modifications and variations can be devised without departing from the scope of the invention.

What is claimed is:

1. A content distribution system in which a content distribution apparatus distributes a content to at least one user terminal,
wherein, in response to a request for use of a content transmitted from the at least one user terminal, and based on information concerning content usage including usage rules which are prescribed respectively corresponding to a plurality of usage modes, the content distribution apparatus dynamically generates a license stipulating a usage rule corresponding to a usage mode of the requested content, and transmits the generated license to the user terminal, and
the user terminal controls use of the content in accordance with the received license.

2. The content distribution system according to claim 1,
wherein each usage mode is defined as a data format of a content, and the content distribution apparatus generates the license so as to stipulate a usage rule corresponding to a data format of the content designated in the request for use.

3. The content distribution system according to claim 1,
wherein each usage mode is defined as capabilities of the at least one user terminal, and the content distribution apparatus generates the license so as to stipulate a usage rule corresponding to the capabilities of the user terminal from which the request for use is transmitted.

4. The content distribution system according to claim 1,
wherein the content distribution apparatus comprises:
a user database operable to store user-related information;
a content right database operable to store, for each content, information concerning content usage including usage rules which are prescribed respectively corresponding to a plurality of usage modes;
a user's right database operable to store a right granted to a user;
a content database operable to store contents;
a user right registration section operable to register a right granted to a user having purchased a content in the user's right database based on the user-related information and the information concerning content usage;
a user right generation section operable to generate, in response to a request for use of a content transmitted from the at least one user terminal, a license including a usage rule corresponding to the usage mode of the requested content;
a content management section in charge of management/control of contents; and
a communication section operable to transmit and receive the license, the content, and the request for use to/from the user terminal, and
wherein the user terminal comprises:
a communication section operable to transmit and receive the request for use, the license, and the content to/from the content distribution apparatus;
a license database operable to store the received license;
a content storage section operable to store the received content; and
a management section in charge of use and management of the received content according to the license stored in the license database.

5. The content distribution system according to claim 2,
wherein the content distribution apparatus comprises:
a user database operable to store user-related information;
a content right database operable to store, for each content, information concerning content usage including usage rules which are prescribed respectively corresponding to a plurality of usage modes;
a user's right database operable to store a right granted to a user;
a content database operable to store contents;
a user right registration section operable to register a right granted to a user having purchased a content in the user's right database based on the user-related information and the information concerning content usage;
a user right generation section operable to generate, in response to a request for use of a content transmitted from the at least one user terminal, a license including a usage rule corresponding to the usage mode of the requested content;
a content management section in charge of management/control of contents; and
a communication section operable to transmit and receive the license, the content, and the request for use to/from the user terminal, and
wherein the user terminal comprises:
a communication section operable to transmit and receive the request for use, the license, and the content to/from the content distribution apparatus;
a license database operable to store the received license;
a content storage section operable to store the received content; and
a management section in charge of use and management of the received content according to the license stored in the license database.

6. The content distribution system according to claim 3,
wherein the content distribution apparatus comprises:
a user database operable to store user-related information;
a content right database operable to store, for each content, information concerning content usage including usage rules which are prescribed respectively corresponding to a plurality of usage modes;
a user's right database operable to store a right granted to a user;
a content database operable to store contents;
a user right registration section operable to register a right granted to a user having purchased a content in the user's right database based on the user-related information and the information concerning content usage;
a user right generation section operable to generate, in response to a request for use of a content transmitted from the at least one user terminal, a license including a usage rule corresponding to the usage mode of the requested content;
a content management section in charge of management/control of contents; and
a communication section operable to transmit and receive the license, the content, and the request for use to/from the user terminal, and
wherein the user terminal comprises:
a communication section operable to transmit and receive the request for use, the license, and the content to/from the content distribution apparatus;
a license database operable to store the received license;
a content storage section operable to store the received content; and
a management section in charge of use and management of the received content according to the license stored in the license database.

7. A content distribution method for allowing a content distribution apparatus to distribute a content to at least one user terminal,
wherein, at a time of content purchasing,
the user terminal notifies to the content distribution apparatus that a content is purchased in a usage mode;
the content distribution apparatus registers user-related information concerning a user having purchased a content, and registers a right granted to the user having purchased the content based on information concerning content usage including usage rules which are prescribed respectively corresponding to a plurality of usage modes and based on the user-related information, and
wherein, at a time of content using,
the user terminal transmits to the content distribution apparatus a request for use of a content including information concerning a usage mode of the content;
in accordance with the request for use transmitted from the user terminal, the content distribution apparatus dynamically generates a license stipulating a usage rule corresponding to the usage mode of the requested content, and transmits the generated license to the user terminal; and
the user terminal uses and manages the requested content in accordance with the license transmitted from the content distribution apparatus.

8. The content distribution method according to claim 7,
wherein, at the time of content purchasing, the user terminal transmits a request to purchase a content to the content distribution apparatus, and
wherein the content distribution apparatus transmits the information concerning content usage to the user terminal.

9. The content distribution method according to claim 7,
wherein each usage mode is defined as a data format of a content, and the content distribution apparatus generates the license so as to stipulate a usage rule corresponding to a data format of the content designated in the request for use.

10. The content distribution method according to claim 8,
wherein each usage mode is defined as a data format of a content, and the content distribution apparatus generates the license so as to stipulate a usage rule corresponding to a data format of the content designated in the request for use.

11. The content distribution method according to claim 7,
wherein each usage mode is defined as capabilities of the at least one user terminal, and the content distribution apparatus generates the license so as to stipulate a usage rule corresponding to the capabilities of the user terminal from which the request for use is transmitted.

12. The content distribution method according to claim 8,
wherein each usage mode is defined as capabilities of the at least one user terminal, and the content distribution apparatus generates the license so as to stipulate a usage rule corresponding to the capabilities of the user terminal from which the request for use is transmitted.

13. The content distribution method according to claim 9,
wherein, before receiving the request for use, the content distribution apparatus transmits to the user terminal at least one content corresponding to a data format to be subsequently requested or the capabilities of the user terminal.

14. The content distribution method according to claim 10,
wherein, before receiving the request for use, the content distribution apparatus transmits to the user terminal at least one content corresponding to a data format to be subsequently requested or the capabilities of the user terminal.

15. The content distribution method according to claim 11,
wherein, before receiving the request for use, the content distribution apparatus transmits to the user terminal at least one content corresponding to a data format to be subsequently requested or the capabilities of the user terminal.

16. The content distribution method according to claim 12,
wherein, before receiving the request for use, the content distribution apparatus transmits to the user terminal at least one content corresponding to a data format to be subsequently requested or the capabilities of the user terminal.

17. The content distribution method according to claim 9,
wherein, after responding to the request for use, the content distribution apparatus transmits to the user terminal the content corresponding to the requested data format or the capabilities of the user terminal.

18. The content distribution method according to claim 10,
wherein, after responding to the request for use, the content distribution apparatus transmits to the user terminal the content corresponding to the requested data format or the capabilities of the user terminal.

19. The content distribution method according to claim 11,
wherein, after responding to the request for use, the content distribution apparatus transmits to the user terminal the content corresponding to the requested data format or the capabilities of the user terminal.

20. The content distribution method according to claim 12,
wherein, after responding to the request for use, the content distribution apparatus transmits to the user terminal the content corresponding to the requested data format or the capabilities of the user terminal.

21. A content distribution program executed by a content distribution apparatus for distributing a content to at least one user terminal, comprising:
a step of registering user-related information concerning a user having purchased a content;
a step of registering a right granted to the user having purchased the content based on information concerning content usage including usage rules which are prescribed respectively corresponding to a plurality of usage modes and based on the user-related information;
a step of dynamically generating a license stipulating a usage rule corresponding to the usage mode of the requested content, in accordance with the request for use transmitted from the user terminal at a time of content using; and
a step of transmitting the generated license to the user terminal.

22. The program according to claim 21,
wherein the step of dynamically generating the license comprises generating the license so as to stipulate a usage rule corresponding to a data format of the content designated in the request for use.

23. The program according to claim 21,
wherein the step of dynamically generating the license comprises generating the license so as to stipulate a usage rule corresponding to the capabilities of the user terminal from which the request for use is transmitted.

24. A content distribution program to be executed by at least one user terminal receiving a content distributed from a content distribution apparatus, comprising:
a step of, at a time of content purchasing, notifying to the content distribution apparatus that a content is purchased in a usage mode;
a step of, at a time of content using, transmitting to the content distribution apparatus a request for use of a content including information concerning a usage mode of the content; and
a step of using and managing the requested content in accordance with the license transmitted from the content distribution apparatus.

25. A recording medium having recorded thereon a content distribution program executed by a content distribution apparatus for distributing a content to at least one user terminal, the program at least comprising:
a step of registering user-related information concerning a user having purchased a content;
a step of registering a right granted to the user having purchased the content based on information concerning content usage including usage rules which are prescribed respectively corresponding to a plurality of usage modes and based on the user-related information;
a step of dynamically generating a license stipulating a usage rule corresponding to the usage mode of the requested content, in accordance with the request for use transmitted from the user terminal at a time of content using; and
a step of transmitting the generated license to the user terminal.

26. The recording medium according to claim 25,
wherein the step of dynamically generating the license comprises generating the license so as to stipulate a usage rule corresponding to a data format of the content designated in the request for use.

27. The recording medium according to claim 25,
wherein the step of dynamically generating the license comprises generating the license so as to stipulate a usage rule corresponding to the capabilities of the user terminal from which the request for use is transmitted.

28. A recording medium having recorded thereon a content distribution program to be executed by at least one user terminal receiving a content distributed from a content distribution apparatus, the program at least comprising:
a step of, at a time of content purchasing, notifying to the content distribution apparatus that a content is purchased in a usage mode;
a step of, at a time of content using, transmitting to the content distribution apparatus a request for use of a content including information concerning a usage mode of the content; and
a step of using and managing the requested content in accordance with the license transmitted from the content distribution apparatus.

29. A content distribution apparatus for distributing a content to at least one user terminal, comprising:
a user database operable to store user-related information;
a content right database operable to store, for each content, information concerning content usage including usage rules which are prescribed respectively corresponding to a plurality of usage modes;
a user's right database operable to store a right granted to a user;
a content database operable to store contents;
a user right registration section operable to register a right granted to a user having purchased a content in the user's right database based on the user-related information and the information concerning content usage;
a user right generation section operable to generate, in response to a request for use of a content transmitted from the at least one user terminal, a license including a usage rule corresponding to the usage mode of the requested content;
a content management section in charge of management/control of contents; and
a communication section operable to transmit and receive the license, the content, and the request for use to/from the user terminal.

30. The content distribution apparatus according to claim 29,
wherein each usage mode is defined as a data format of a content, and
wherein the user right generation section generates the license so as to stipulate a usage rule corresponding to a data format of the content designated in the request for use.

31. The content distribution apparatus according to claim 29,
wherein each usage mode is defined as capabilities of the at least one user terminal, and
wherein the user right generation section generates the license so as to stipulate a usage rule corresponding to the capabilities of the user terminal from which the request for use is transmitted.
